(19) United States
(12) Patent Application Publication
(10) Pub. No.: US 2002/0109605 A1
(43) Pub. Date: Aug. 15, 2002

(54) Gauge illuminated by full color led lamp pre-programmed by IC chip to flash in colors of various tones automatically

(76) Inventor: Paul Liu, Taipei (TW)

Correspondence Address: BROWDY AND NEIMARK, P.L.L.C., 624 NINTH STREET, NW, SUITE 300, WASHINGTON, DC, 20001-5303, US

(21) Appl. No.: 09/783,289

(22) Filed: Feb. 15, 2001

(51) Int. Cl. G08B 5/00

(52) U.S. Cl. 340/815.65; 340/815.4

(57) ABSTRACT

A light illuminated gauge mounted to common vehicles, ships, aircraft and etc., is equipped with a full color LED lamp capable of producing light of red, green and blue basic colors separately or in combination and controlled by an IC chip so as to generate light of colors of various tones automatically. The gauge is provided with a function button and a setting button and an LCD display for a user to manually set the operational modes. The full color LED lamp has three pins that are coupled to the IC chip that is connected to the setting button and the function button whereby a person can selectively input operation parameters and randomly choose illumination colors for each display in response to the set conditions or limits. An alarm buzzer or a phonetic message generator can be also coupled to the particular IC chip so as to enable the gauge to transmit alarm messages to a driver when a threatening situation is taking place simultaneously with the variation of illumination lamp color.

### BACKGROUND OF THE INVENTION

The present invention relates to a light illuminated gauge mounted to common vehicles, ships, aircraft and etc., which is equipped with a full color LED lamp capable of producing light in basic color of red, green separately or in combination and controlled by an IC chip so as to generate light in colors of various tones automatically. The gauge is provided with a function button and a setting button and a LCD display for a user to manually setting the operational modes. The full color LED lamp has three pins that are coupled to the IC chip that is connected to the setting button and the function button whereby a person can selectively input operation parameters and randomly choose illumination colors for each display in response to the set conditions or limits. An alarm buzzer or a phonetic message generator can be also coupled to the particular IC chip so as to enable the gauge to transmit alarm messages to a driver when a threatening situation is going to take place.

Generally speaking, there are several conventional gauges illuminated by variable light means which range from light bulbs covered with silicon colored light boots, full color LED bulbs and electronic luminescent plates. Such prior light illuminated gauges can be set in advance manually to flash in different colors in response to preset conditions or they can be instantly changed of their colors by a person who presses a certain setting button. These prior gauges have the following disadvantages in practical use.

1. The silicon colored light boots are not able to produce illumination light in a satisfactory manner.

2. The electronic luminescent plates are easily degenerated after a certain period of time.

3. There is no display means provided on such a prior gauge to display the operation conditions of the gauge.

4. The gauges are to be set only to vary the colors of the illumination light, no buzzer or phonetic message generators are provided to further alarm a driver on road.

### SUMMARY OF THE INVENTION

Therefore, the primary object of the present invention is to provide a light illuminated gauge programmably controlled by an IC chip to produce light in colors of various tones in response to preset operation modes by a user whereby a gauge can be illuminated in light of different colors accordingly.

Another object of the present invention is to provide a light illuminated gauge which is provided with an LCD display, a function button and a setting button that are connected to the IC chip whereby various operation modes can be preset to permit a full color LED lamp to produce colors of various tones in response to preset operation conditions automatically.

One further object of the present invention is to provide a light illuminated gauge controlled by an IC chip which is further associated with a buzzer or a phonetic message generator that can be actuated to function when preset operation modes are met in addition to the variation of light illumination colors of the gauge.

### BRIEF DESCRIPTION OF THE DRAWINGS

FIG. 1 is a perspective diagram showing the light illuminated gauge of the present invention;

FIG. 2 is a diagram showing the full color LED lamp of the present invention;

FIG. 3 is a diagram showing the core of the gauge of the present invention;

FIG. 4 is a block diagram of the IC chip thereof;

FIG. 5 is a diagram showing the detailed circuit of the IC chip of the present invention.

### DETAILED DESCRIPTION OF THE PREFERRED EMBODIMENT

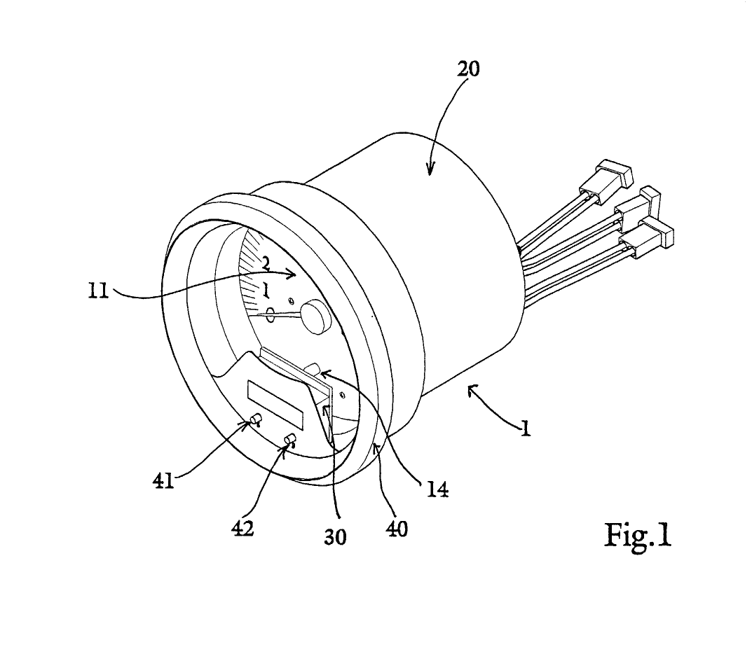

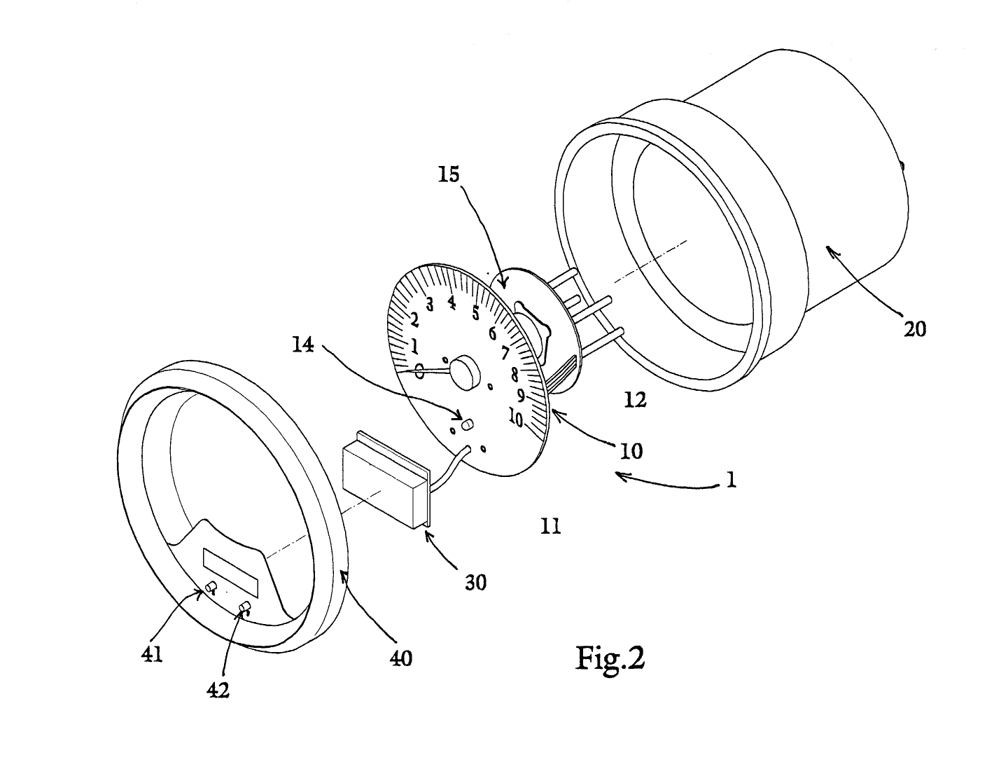

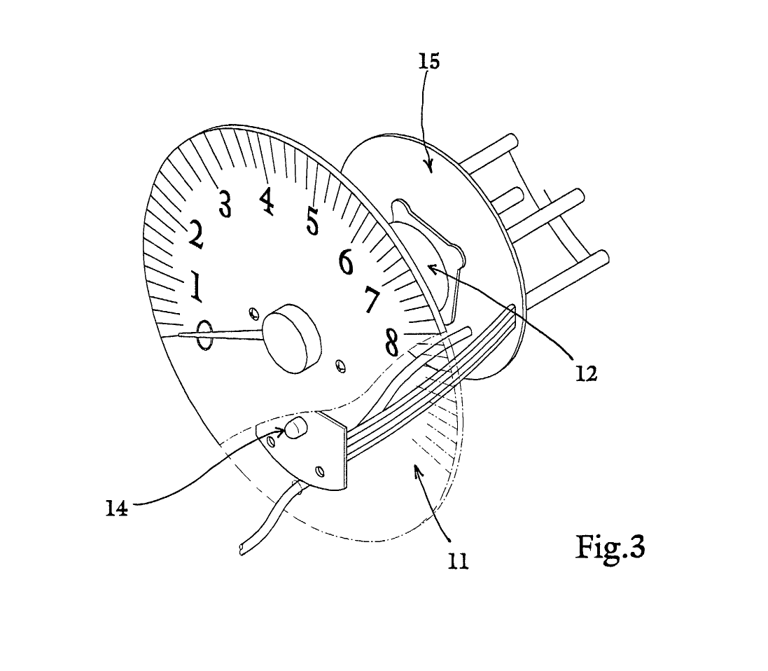

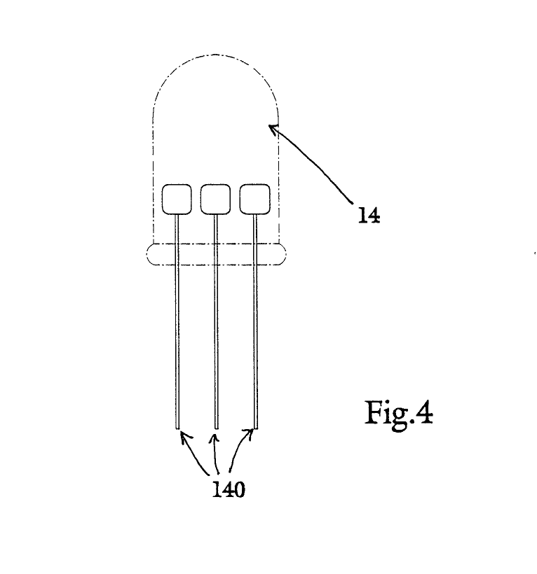

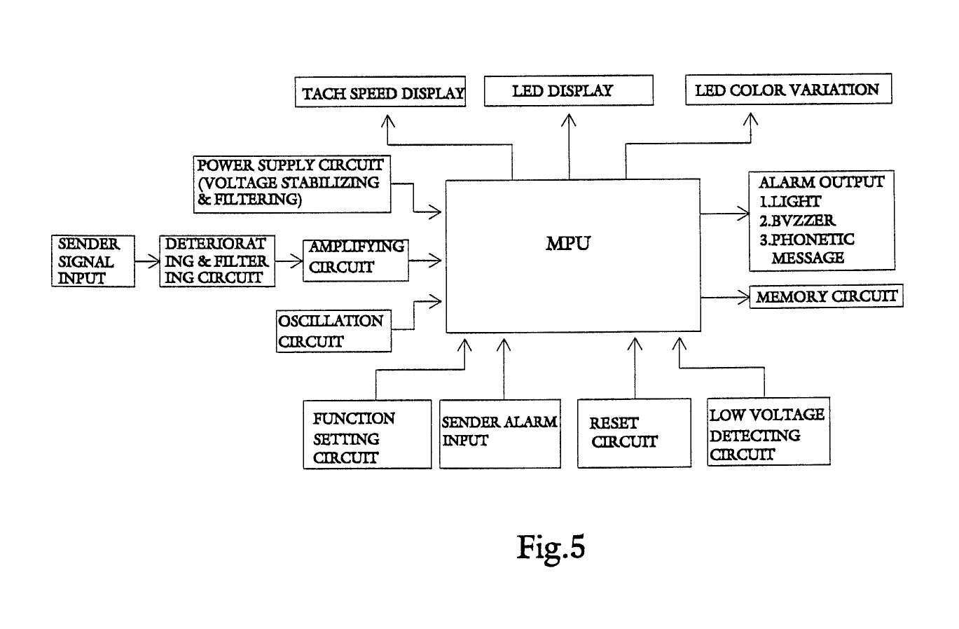

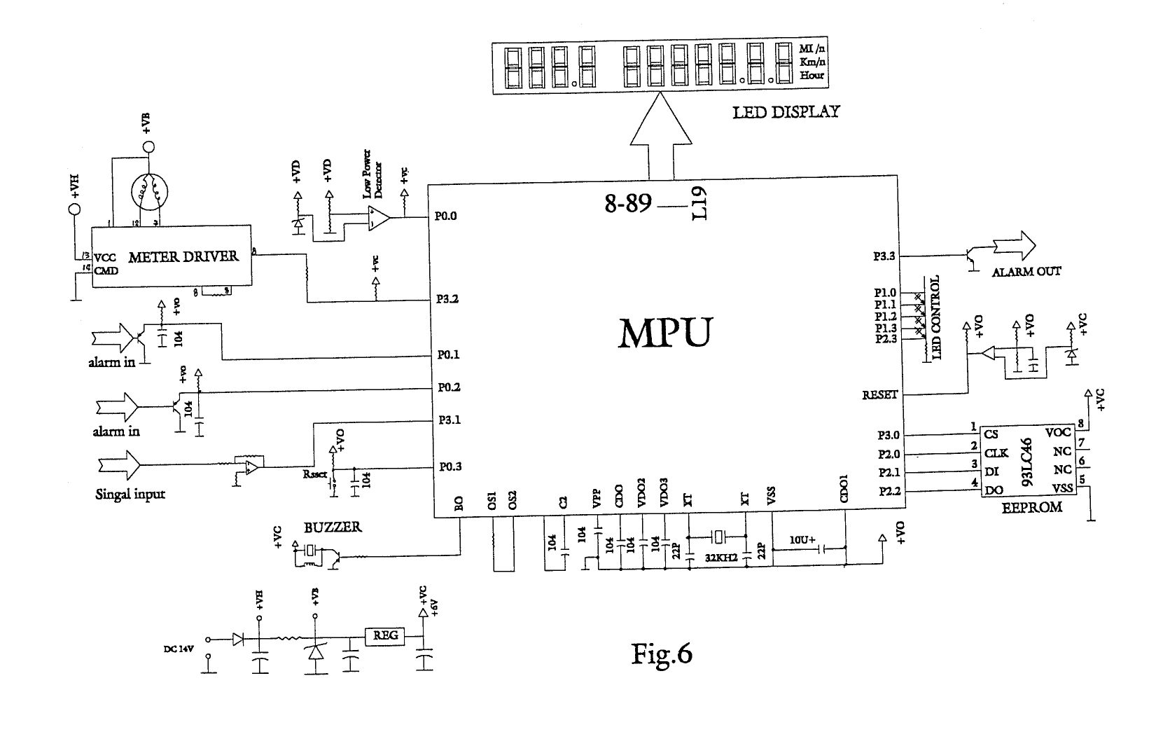

Referring to FIG. 1, a light illuminated gauge 1 equipped with a full color LED lamp 10 of the present invention is particularly provided with an LCD display 12 which is positioned on the front glass 11 of the gauge 1. The gauge 1 has an IC chip MPU 20 which is particularly equipped with a power supply circuitry which is adapted for voltage stabilizing and filtering; an amplifying circuitry; an oscillation circuitry; a function setting circuitry; a sender alarm input; a reset circuitry; a low voltage detecting circuitry; a memory circuitry; an alarm output including light lamp output, buzzer output and phonetic output; a full color LED lamp illumination; an LCD display and a tachspeed display.

The full color LED lamp has 3 pins that can separately produce light of 3 basic colors, red, blue and green. Accordingly light of various colors and tones can be generated by the full color LED lamp whose 3 pins are connected to the IC chip to make the 3 basic colors controllably produced separately or in combination by the chip.

The MPU is a micro processor unit serving as a system processing center for light color changeable gauges of panels mounted onto vehicles, aircraft and ships; the software of the MPU can be specifically designed according to clients' requirements individually and can perform respective functional variations.

The LCD display is used to digitally illustrate individual functions of a gauge, such as 1. ODO 2. TRIP ODO 3. HOUR 4. TRIP HOUR 5. set SPEED value( RECALL) 6.the set frequency value. The characters and the colors of the illustrated digits on the LCD display can be varied by the circuit of the MPU accordingly so that color variations of the gauges can be effected.

The full color LED lamp having 3 pins (red, blue and green) can be controlled by the MPU and resistors to produce in proportion different tones of colors, such as white, blue, light blue, green, yellow, purple, red, resulting in the color variations of gauges on a panel.

A TACH/SPEED display is designed to be applicable to all types of vehicle engines and to various SENDERS, such as IGNITION COIL, ALTERNATOR, PULSE GENERATOR, MAGNETIC PROXIMITY AND HALL EFFECT SENDER. As long as a user sets the operation functions and frequencies thereof, then a gauge can display the engine speed and vehicle speed.

The power supply circuitry is used to get an input power supply stabilized in voltage and filtered so as to supply a set voltage, 12 V or 24 V for the present invention, for a circuit system of the color changeable gauge of the present invention.

The SENDER signal input can be delivered to a gauge by simply connecting the positive and negative ends to the signal input ends so that the gauge can be activated accordingly.

The attenuation and filter circuitry attenuates the input signals in a proper manner and filters the unnecessary noise so as to produce input signals in a better shape.

The amplifying circuitry attenuates and filters the input signals of SENDER to get signals in better wave shapes which are then amplified and transmitted to the MPU for processing and then activate a gauge to display respective information thereon.

The oscillation circuit produces oscillating frequency for the MPU as a source of oscillation in operation.

The function setting circuit uses setting buttons and a specifically designed software to variably set the following functions:

1. The ODO is able to count number of times and to accumulate travelling miles of a vehicle.

2. The TRIP is able to count number of times and to accumulate travelling miles of a vehicle and can reset to zero for another number counting.

3. The HOUR is used to count number of times and the total hours of engine operation of a vehicle.

4. The TRIP HOUR is able to count number of times, the accumulate the total hours of engine operation of a vehicle, the time of a single trip and can be reset for another time counting.

5. The setting of over speed permits the setting of different types of alarm as an engine speed or a vehicle speed excesses a set value.

6. The setting of frequency permits the calculation of proper frequencies for different kinds of vehicles and various kinds of sensors mounted on such vehicles so as to make gauges operate normally after the frequencies being set.

7. The setting of color change permits a person to alternatively set different colors for gauge illumination as one prefers so as to make a gauge to illuminate in different colors in alarm situations.

The input of SENDER ALARM can make use of different types of sensors, such as pressure sensors, temperature sensors, oil level sensors that can issue alarm signals to the MPU for processing so as to permit gauges to transmit different alarm signals.

The reset circuitry works on the electric circuit system of the MPU and provide for the setting operations on various functions, such as ODO, TRIP ODO, HOUR, TRIP HOUR and etc..

The low voltage detecting circuitry enables a memory circuitry to correctly record the related information as soon as the power is turned “OFF” with its voltage dropped to a certain level, the low voltage detecting circuitry will output a signal to activate the memory circuitry to immediately get related information recorded in time.

The memory circuitry can operate in response to the MPU in such a manner that on the power being turned “OFF”, related data can be automatically recorded immediately and on the power being turned “ON”, the related documents, such as ODO, TRIP ODO, HOUR, TRIP HOUR, SPEED SET (RECALL) and FREQUENCY SET can be picked out right away.

The LCD display coupled to the IC chip MPU is additionally provided to show the setting and function operations on the IC chip in practical use.

In particular, the IC chip can output 3 types of alarm, including a variably colored light illumination, a buzzer alarm and a phonetic message alarm whereby a driver can be alarmed of operational hazards via a gauge on vehicles, aircraft and ships.

The present invention is characterized in that the IC chip is provided with a function setting circuitry which is activated by a function setting key and a setting key to input operation modes in advance; and an LCD display that can demonstrate the operational conditions of a gauge in addition to the setting operations.

The IC chip can automatically pick out the memory content in a memory unit when the engine is switched on; and the memory unit is automatically actuated to store the input variations therein when the engine is switched off The memory unit can be played back or recalled for review.

The LED lamp can be set by hand of its colors of illumination according to individual preference one by one.

The LED lamp can be set to light in red above an alarm condition and manually and light in other variable colors in a particular pattern as one prefers.

It is also possible to set the LED lamp to operate in an automatic manner by way of the IC chip so as to permit the light of the lamp to vary its colors of illumination automatically.

The main gauge can be hooked up to a plurality of minor gauges so as to allow the minor gauges to be illuminated in the same colors and patterns as the main gauge Besides, the gauge is not only able to produce light of different colors for alarming purpose but also can produce alarm by a buzzer or a phonetic message generator when a speed limit or engine speed is over a set value

I claim:

1. A light illuminated gauge including a full color LED lamp, a gauge core, an IC chip and an LCD display adapted for use in vehicles, aircraft, ships and the like; wherein:
an MPU is a micro processor unit serving as a system processing center for light color changeable gauges of panels mounted onto vehicles, aircraft and ships; the software of the MPU can be specifically designed according to clients' requirements individually and can perform respective functional variations;
said LCD display is used to digitally illustrate individual functions of a gauge, such as 1. ODO 2. TRIP ODO 3. HOUR 4. TRIP HOUR 5. set SPEED value( RECALL) 6.the set frequency value; the characters and the colors of the illustrated digits on the LCD display can be varied by the circuit of the MPU accordingly so that color variations of the gauges can be effected;
said full color LED lamp having 3 pins (red, blue and green) can be controlled by the MPU and resistors to produce in proportion different tones of colors, such as white, blue, light blue, green, yellow, purple, red, resulting in the color variations of gauges on a panel;
a TACH/SPEED display is designed to be applicable to all types of vehicle engines and to various SENDERS, such as IGNITION COIL, ALTERNATOR, PULSE GENERATOR, MAGNETIC PROXIMITY AND HALL EFFECT SENDER; as long as a user sets the operation functions and frequencies thereof, then a gauge can display the engine speed and vehicle speed;
a power supply circuitry is used to get an input power supply stabilized in voltage and filtered so as to supply a set voltage, 12 V or 24 V for the present invention, for a circuit system of the color changeable gauge;
said SENDER signal input can be delivered to a gauge by simply connecting the positive and negative ends to the signal input ends so that the gauge can be activated accordingly;
an attenuation and filter circuitry attenuates the input signals in a proper manner and filters the unnecessary noise so as to produce input signals in a better shape;
an amplifying circuitry attenuates and filters the input signals of SENDERS to get signals in better wave shapes which are then amplified and transmitted to the MPU for processing and then activate a gauge to display respective information thereon;
an oscillation circuit produces oscillating frequency for the MPU as a source of oscillation in operation;
a function setting circuit uses setting buttons and a specifically designed software to variably set the following functions:
1. The ODO is able to count number of times and to accumulate travelling miles of a vehicle;
2. The TRIP is able to count number of times and to accumulate travelling miles of a vehicle and can reset to zero for another number counting;
3. The HOUR is used to count number of times and the total hours of engine operation of a vehicle;
4. The TRIP HOUR is able to count number of times, the accumulate the total hours of engine operation of a vehicle, the time of a single trip and can be reset for another time counting;
5. The setting of over speed permits the setting of different types of alarm as an engine speed or a vehicle speed excesses a set value;
6. The setting of frequency permits the calculation of proper frequencies for different kinds of vehicles and various kinds of sensors mounted on such vehicles so as to make gauges operate normally after the frequencies being set;
7. The setting of color change permits a person to alternatively set different colors for gauge illumination as one prefers so as to make a gauge to illuminate in different colors in alarm situations;
an input of SENDER ALARM can make use of different types of sensors, such as pressure sensors, temperature sensors, oil level sensors that can issue alarm signals to the MPU for processing so as to permit gauges to transmit different alarm signals;
a reset circuitry works on the electric circuit system of the MPU and provide for the setting operations on various functions, such as ODO, TRIP ODO, HOUR, TRIP HOUR and etc.;
low voltage detecting circuitry enables a memory circuitry to correctly record the related information as soon as the power is turned “OFF” with its voltage dropped to a certain level, the low voltage detecting circuitry will output a signal to activate the memory circuitry to immediately get related information recorded in time;
a memory circuitry can operate in response to the MPU in such a manner that on the power being turned “OFF”, related data can be automatically recorded immediately and on the power being turned “ON”, the related documents, such as ODO, TRIP ODO, HOUR, TRIP HOUR, SPEED SET (RECALL) and FREQUENCY SET can be picked out right away;
said LCD display coupled to the IC chip MPU is additionally provided to show the setting and function operations on the IC chip in practical use;
wherein said gauge is characterized in that the IC chip is provided with a function setting circuitry which is activated by a function setting key and a setting key to input operation modes in advance; and an LCD display that can demonstrate the operational conditions of a gauge in addition to the setting operations; the IC chip can automatically pick out the memory content in a memory unit when the engine is switched on; and the memory unit is automatically actuated to store the input variations therein when the engine is switched off; the memory unit can be played back or recalled for review; said LED lamp can be set by hand of its colors of illumination according to individual preference one by one;
the LED lamp can be set to light in red above an alarm condition and manually and light in other variable colors in a particular pattern as one prefers; the LED lamp can be set to operate in an automatic manner by way of the IC chip so as to permit the light of the lamp to vary its colors of illumination automatically.

2. The light illuminated gauge as claimed in claim 1 wherein said gauge can be hooked up to a plurality of minor gauges whereby said minor gauges can be illuminated in the same colors of said main gauge.

3. The light illuminated gauge as claimed in claim 1 wherein said IC chip can in particular output 3 types of alarm, including a variably colored light illumination, a buzzer alarm and a phonetic message alarm whereby a driver can be alarmed of operational hazards via a gauge on vehicles, aircraft and ships.
